(19) United States
(12) Patent Application Publication
(10) Pub. No.: US 2024/0169738 A1
(43) Pub. Date: May 23, 2024

(54) LOAD FACTOR ESTIMATION DEVICE

(71) Applicant: Isuzu Motors Limited, Yokohama-shi, Kanagawa (JP)

(72) Inventors: Maya MATSUSHITA, Fujisawa-shi, Kanagawa (JP); Tomoaki SHIMOZAWA, Fujisawa-shi, Kanagawa (JP); Yuka MIZUSHI, Fujisawa-shi, Kanagawa (JP)

(73) Assignee: Isuzu Motors Limited, Yokohama-shi, Kanagawa (JP)

(21) Appl. No.: 18/283,006

(22) PCT Filed: Mar. 14, 2022
(86) PCT No.: PCT/JP2022/011271

§ 371 Date: Sep. 20, 2023

(30) Foreign Application Priority Data
Mar. 24, 2021 (JP) 2021-049749

(51) Int. Cl. G06V 20/52; G06T 7/20; G06V 40/10

(52) U.S. Cl. CPC G06V 20/52; G06T 7/20; G06V 40/10; G06T 2207/30196

(57) ABSTRACT

A load factor estimation device with which it is possible to improve the accuracy of estimating a load factor. The load factor estimation device comprises: a recognition unit for acquiring a first image in which the inside of a loading platform is photographed and/or a second image in which a range within a prescribed distance from the entrance of the loading platform is photographed, recognizing and tracking an object other than a person and freight in the acquired image, thereby guessing whether or not an object other than the person and the freight exists in the loading platform; and an estimation unit for estimating the load factor of a vehicle provided with the loading platform when an object other than the person and the freight does exist in the loading platform.

### TECHNICAL FIELD

The present disclosure relates to a loading rate estimation apparatus that is used in a vehicle.

### Background Art

Conventionally, a method of estimating a loading rate of a vehicle equipped with a cargo platform (e.g., cargo compartment, flatbed body, or the like) has been known. For example, Patent Literature (hereinafter referred to as “PTL”) discloses a method of calculating a loading rate based on load amount data in a cargo compartment that has been measured by an ultrasound sensor.

### CITATION LIST

### Patent Literature

### PTL

Japanese Patent Application Laid-Open No. 2004-284722

### SUMMARY OF INVENTION

### Technical Problem

However, the conventional methods have a problem such as reduced accuracy in estimating the loading rate because when a person and/or an object other than a cargo is present on a cargo platform, they are treated in the same manner as the cargo.

An object of one aspect of the present disclosure is to provide a loading rate estimation apparatus capable of improving the estimation accuracy of a loading rate.

### Solution to Problem

A loading rate estimation apparatus according to an aspect of the present disclosure includes: a recognition section that acquires at least one of a first image of a captured inside of a cargo platform and/or a second image of a captured range that is an outside of the cargo platform and within a predetermined distance from a doorway of the cargo platform, recognizes and tracks a person and an object other than a cargo in the acquired image, and thereby infers whether the person and the object other than the cargo are present in the cargo platform; and an estimation section that estimates a loading rate of a vehicle equipped with the cargo platform when neither the person nor the object other than the cargo is present in the cargo platform.

### Advantageous Effects of Invention

According to the present disclosure, it is possible to improve the estimation accuracy of a loading rate.

### BRIEF DESCRIPTION OF DRAWINGS

FIG. 1 is a schematic side view of a vehicle according to an embodiment of the present disclosure;

FIG. 2 is a block diagram illustrating an exemplary configuration of a loading rate estimation apparatus according to the embodiment of the present disclosure; and

FIG. 3 is a flowchart describing an exemplary operation of the loading rate estimation apparatus according to the embodiment of the present disclosure.

### DESCRIPTION OF EMBODIMENTS

Hereinafter, an embodiment of the present disclosure will be described in detail with reference to the drawings.

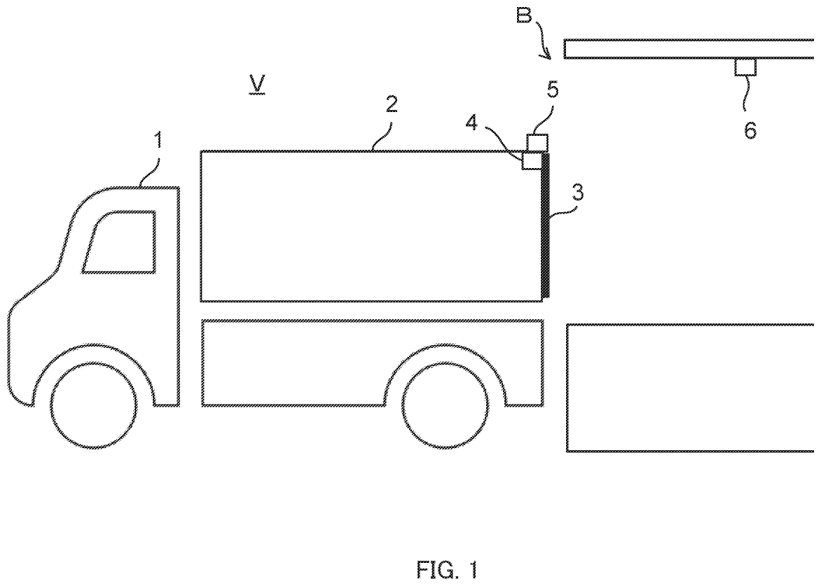

First, vehicle V of the present embodiment will be described with reference to FIG. 1. FIG. 1 is a schematic side view of vehicle V.

As illustrated in FIG. 1, vehicle V is a truck equipped with cab 1 and cargo compartment 2. Incidentally, vehicle V is not limited to a truck and may be another type of vehicle.

Cargo compartment 2 (example of cargo platform) is, for example, box-shaped and has an opening portion (not illustrated; the same applies hereinafter) on a rear side surface as a doorway of cargo compartment 2. Loading and unloading of cargo are carried out through the opening portion.

At the rear of cargo compartment 2, door 3, which is openable and closable, is provided such that the door corresponds to a position of the opening portion. An example of door 3 includes but not limited to a door that opens by rotating, in a left and right direction from a center of the opening portion, about the axes, which are left and right edges of the opening portion (what is called hinged-double type door).

In the rear inside of cargo compartment 2, cargo-compartment inside camera 4 is provided.

Cargo-compartment inside camera 4 captures the entire inside of cargo compartment 2. An image captured with cargo-compartment inside camera 4 is hereinafter referred to as a cargo-compartment inside image (example of first image).

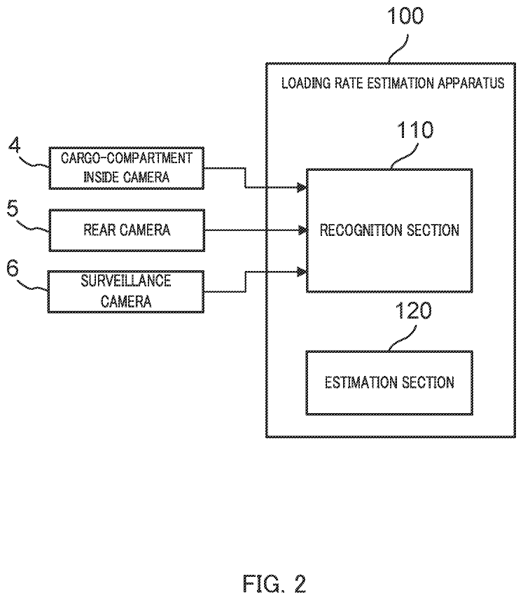

Cargo-compartment inside camera 4 transmits the captured cargo-compartment inside image to loading rate estimation apparatus 100 to be described later (see FIG. 2).

Besides, cargo-compartment inside camera 4 is integrally configured with a depth sensor (not illustrated). The depth sensor is a sensor capable of measuring a distance from itself to a person and/or an object in two dimension. A sensing result of the depth sensor is output to loading rate estimation apparatus 100 to be described later (see FIG. 2). Note that cargo-compartment inside camera 4 and the depth sensor may be units separate from each other.

At the rear outside of cargo compartment 2, rear camera 5 is provided.

Rear camera 5 is a camera that captures an outside and rearward of vehicle V (specifically, vicinity of outside of opening portion). An image captured with rear camera is hereinafter referred to as a first-opening portion vicinity image (example of second image).

For example, a range captured with rear camera 5 does not include the inside of cargo compartment 2 and is a range within a predetermined distance (e.g., several meters) with reference to the opening portion (may be referred to as door 3 illustrated in FIG. 1). That is, the first-opening portion vicinity image is an image of a range that is the outside of cargo compartment 2 and within the predetermined distance from the opening portion.

Rear camera 5 transmits the captured first-opening portion vicinity image to loading rate estimation apparatus 100 to be described later (see FIG. 2).

Installation positions of cargo-compartment inside camera 4 and rear camera 5, respectively, are not limited to the positions illustrated in FIG. 1.

Moreover, although not illustrated in FIG. 1, loading rate estimation apparatus 100 to be described later (see FIG. 2) is further mounted on vehicle V.

In FIG. 1 illustrates a state where vehicle V stops near berth B. Berth B is a space provided in logistics facilities (e.g., warehouses, distribution centers, and the like) and used for operations such as loading or unloading in cargo compartment 2.

As illustrated in FIG. 1, surveillance camera 6 is installed at an upper portion (e.g., ceiling portion) of berth B.

Surveillance camera 6 captures the vicinity of an entrance of berth B. Therefore, for example, as illustrated in FIG. 1, when vehicle V stops with its rear near to the vicinity of the entrance of berth B, surveillance camera 6 captures an outside and rearward of vehicle V (specifically, vicinity of outside of opening portion). An image captured with surveillance camera 6 is hereinafter referred to as a second-opening portion vicinity image (example of second image). The second-opening portion vicinity image is an image of a range that is the outside of cargo compartment 2 and within the predetermined distance from the opening portion, as with the first-opening portion vicinity image. Incidentally, the second-opening portion vicinity image may further include an image of the inside of cargo compartment 2 (in this case, it can be said that second-opening portion vicinity image is an example of first image as well as an example of the second image).

Surveillance camera 6 transmits the captured second-opening portion vicinity image to loading rate estimation apparatus 100 to be described later (see FIG. 2).

Incidentally, when surveillance camera 6 has a radio communication function, surveillance camera 6 may directly transmit, by radio, the second-opening portion vicinity image to loading rate estimation apparatus 100. When surveillance camera 6 has no radio communication function, surveillance camera 6 may transmit, by wire, the second-opening portion vicinity image to a radio communication apparatus (not illustrated) installed in berth B, and then, the radio communication apparatus may transmit the second-opening portion vicinity image to loading rate estimation apparatus 100 by radio.

Vehicle V has been described, thus far.

Next, loading rate estimation apparatus 100 of the present embodiment will be described with reference to FIG. 2. FIG. 2 is a block diagram illustrating an exemplary configuration of loading rate estimation apparatus 100.

As mentioned above, loading rate estimation apparatus 100 illustrated in FIG. 2 is mounted on vehicle V illustrated in FIG. 1.

Although not illustrated, loading rate estimation apparatus 100 includes, as hardware, a Central Processing Unit (CPU), a Read Only Memory (ROM) that stores computer programs therein, and a Random Access Memory (RAM), for example. The functions of the apparatuses described below are realized by the CPU executing a computer program read from the ROM in the RAM. For example, loading rate estimation apparatus 100 may be realized by an Electronic Control Unit (ECU).

As illustrated in FIG. 2, loading rate estimation apparatus 100 includes recognition section 110 and estimation section 120.

Recognition section 110 acquires a cargo-compartment inside image from cargo-compartment inside camera 4, acquires a first-opening portion vicinity image from rear camera 5, and acquires a second-opening portion vicinity image from surveillance camera 6. The cargo-compartment inside image, the first-opening portion vicinity image, and the second-opening portion vicinity image (hereinafter collectively also referred to as “respective images”) are, for example, moving images that are captured in real time.

Then, recognition section 110 recognizes and tracks, in the respective images, a person and an object other than a cargo and thereby infers whether the person and the object other than the cargo are present in cargo compartment 2.

The term “person” used herein refers to, for example, an operator who carries out an operation such as loading or unloading in cargo compartment 2. Further, the term “object other than a cargo (hereinafter simply also referred to as object)” used herein refers to a working tool (e.g., bucket, stepladder, roller conveyor, and the like) used by the operator in the above-mentioned operation.

A publicly known technique can be applied to methods of recognizing and tracking a person and an object, which are performed in recognition section 110. Examples of the publicly known techniques include but not limited to, for example, recognition techniques on images using deep learning and the like (e.g., see Japanese Patent Application Laid Open No. 2020-68008 and Japanese Patent Application Laid Open No. 2020-204804) and tracking techniques on images (e.g., see Japanese Patent Application Laid Open No. 2012-108798 and Japanese Patent Application Laid Open No. 2020-91664).

When recognition section 110 infers that neither a person nor an object other than a cargo is present in cargo compartment 2, estimation section 120 estimates a loading rate of vehicle V based on a sensing result of the depth sensor. The loading rate is a ratio of a volume of cargo placed in cargo compartment 2 to the maximum loading volume of vehicle V.

A publicly known technique can be applied to an estimation method of the loading rate performed in estimation section 120. Examples of the publicly known techniques include but are not limited to, for example, methods disclosed in Japanese Patent Application Laid Open No. 2003-35527, <URL:https://creanovo.de/portfolio/wabco-cargocam/>, <URL:https://www.ncos.co.jp/news/new_s 210113.html>, and the like.

Estimation section 120 may output (transmit) information indicating the estimated loading rate to a predetermined apparatus that is not illustrated. Examples of the predetermined apparatuses include a broadcast apparatus mounted in cab 1 (e.g., display, speaker, and the like), a computer installed outside vehicle V (e.g., server apparatus on network), and the like.

The configuration of loading rate estimation apparatus 100 has been described, thus far.

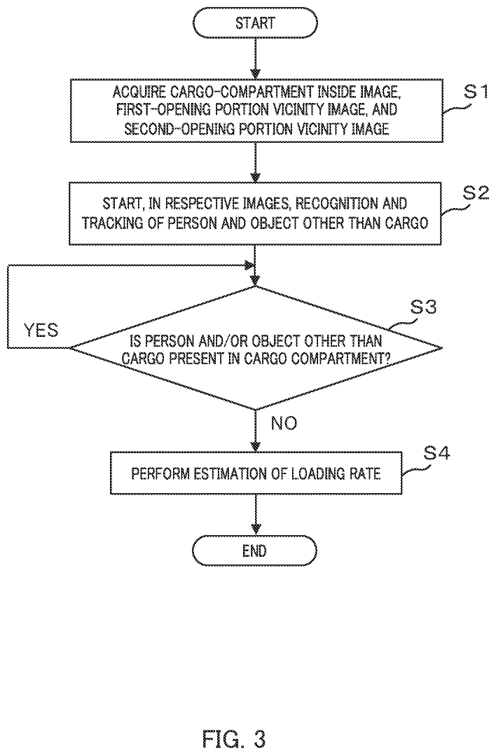

Next, an operation of loading rate estimation apparatus 100 will be described with reference to FIG. 3. FIG. 3 is a flowchart describing an exemplary operation of loading rate estimation apparatus 100. The flow of FIG. 3 may be started when vehicle V stops or when vehicle V stops and door 3 is in an open state, for example.

First, recognition section 110 acquires a cargo-compartment inside image, a first-opening portion vicinity image, and a second-opening portion vicinity image (step S1).

Next, recognition section 110 starts, in the respective images, recognition and tracking of a person and an object other than a cargo (step S2). This allows recognition section 110 to infer whether a person and an object other than a cargo are present in cargo compartment 2 (step S3).

The recognition, tracking, and inference described above are repeated when a person and/or an object other than a cargo is present in cargo compartment 2 (step S3: YES).

In a case where recognition section 110 infers that neither a person nor an object other than a cargo is present in cargo compartment 2 (step S3: NO), estimation section 120 performs estimation of a load rate (step S4).

The operation of loading rate estimation apparatus 100 has been described, thus far.

As described in detail above, loading rate estimation apparatus 100 of the present embodiment is characterized by performing estimation of a loading rate of vehicle V when it is estimated that neither a person nor an object other than a cargo is present in cargo compartment 2 based on a cargo-compartment inside image, a first-opening portion vicinity image, and a second-opening portion vicinity image.

Thus, loading rate estimation apparatus 100 of the present embodiment is capable of improving the estimation accuracy of a loading rate.

The present disclosure is not limited to the description of the above embodiment, and various modifications can be made without departure from the spirit of the disclosure. In the following, variations will be described.

### Variation 1

In the embodiment, a case has been described as an example where door 3 of cargo compartment 2 is provided at the rear (may be referred to as back surface) of cargo compartment 2, but the present disclosure is not limited to this case.

In one example, an opening portion and door 3 of cargo compartment 2 may be provided on a side (specifically, at least one of left side and right side) of cargo compartment 2. In this case, instead of rear camera 5, it is sufficient to use, for example, a camera that captures an outside and side of vehicle V (specifically, vicinity of outside of opening portion).

### Variation 2

In the embodiment, a case has been described as an example where vehicle V is equipped with cargo compartment 2 as a cargo platform, but the present disclosure is not limited to this case.

Vehicle V may be a vehicle equipped with a flatbed body (example of cargo platform) in place of cargo compartment 2. In this case, instead of cargo-compartment inside camera 4, it is sufficient to use, for example, a camera that is provided in cab 1 (e.g., outside and rear of cab 1) and captures the entire area on the flatbed body. Further, in this case, instead of rear camera 5, it is sufficient to use, for example, a camera that is provided in the flatbed body and captures a range which is the outside of the flatbed body and within a predetermined distance from a doorway of the flatbed body.

### Variation 3

In the embodiment, a case has been described as an example where three types of captured images (e.g., cargo-compartment inside image, first-opening portion vicinity image, and second-opening portion vicinity image) are used, but the present disclosure is not limited to this. At least one of the three types of captured images may be used.

First, a case will be described where only the cargo-compartment inside image is used.

In this case, estimation section 120 performs estimation of a loading rate at the time when a person and an object are no longer recognized in the cargo-compartment inside image.

Next, a case will be described where only the first-opening portion vicinity image is used.

In this case, an example will be described in which, in the first-opening portion vicinity image, one operator is first recognized in the vicinity of an outside of the opening portion. Note that, as mentioned above, the first-opening portion vicinity image does not include an image of the inside of cargo compartment 2.

Recognition section 110 recognizes that the recognized operator is present in cargo compartment 2 when the recognized operator disappears from the first-opening portion vicinity image by moving toward a predetermined direction of the opening portion (direction in image known to recognition section 110; hereinafter, referred to as opening portion direction), in the first-opening portion vicinity image. In this situation, estimation section 120 performs no estimation of the loading rate.

Thereafter, recognition section 110 recognizes that the recognized worker is absent in cargo compartment 2 when the recognized worker appears from the opening portion direction, in the first-opening portion vicinity image. At this time, estimation section 120 performs the estimation of the loading rate.

Thus, even when using only the first-opening portion vicinity image not including the image of the inside of cargo compartment 2, it is possible to recognize whether a person is present in cargo compartment 2. Note that, in the above description, an example has been given in which one operator has moved into cargo compartment 2, but even when a plurality of operators moves into cargo compartment 2 or when an operator moves into cargo compartment 2 with an operation tool, the presence or absence of an operator or an operation tool in cargo compartment 2 can be recognized in the same manner as above.

Next, a case will be described where only the second-opening portion vicinity image is used.

In a situation where the second-opening portion vicinity image includes an image of the inside of cargo compartment 2, estimation section 120 performs the estimation of the loading rate at the time when recognition section 110 recognizes and tracks a person and an object in the second-opening portion vicinity image and then infers that they are no longer present in cargo compartment 2. On the other hand, when the second-opening portion vicinity image includes no image of the inside of cargo compartment 2, the operations of recognition section 110 and estimation section 120 are the same as those of the above case where only the first-opening portion vicinity image is used.

In the above description, cases have been each described as an example where one of the cargo-compartment inside image, the first-opening portion vicinity image, and the second-opening portion vicinity image is used, but two of the cargo-compartment inside image, the first-opening portion vicinity image, and the second-opening portion vicinity image may be used.

As described above, even when using one type of camera (one type of captured image), it is possible to achieve an improvement in the estimation accuracy of a loading rate. However, using multiple types of cameras (multiple types of captured images) as in the embodiment further improves the accuracy of recognition and tracking. Hence, in the embodiment, the estimation accuracy of the loading rate is improved as compared with the present variation.

In addition, when at least one of the first-opening portion vicinity image and the second-opening portion vicinity image is used, rear camera 5 and surveillance camera 6, which are existing equipment, can be utilized. In this case, there is no need to install cargo-compartment inside camera 4 inside cargo compartment 2 (since only depth sensor is needed in cargo compartment 2), which can suppress the cost. That is, it is possible to perform estimation of a loading rate accurately with a low-cost and simple configuration.

### Variation 4

In the embodiment, a case has been described as an example where loading rate estimation apparatus 100 is mounted on vehicle V, but the present disclosure is not limited to this case. In one example, loading rate estimation apparatus 100 may be realized by a computer (e.g., server and the like) installed outside vehicle V. In this case, for example, a communication apparatus mounted on vehicle V (not illustrated) may transmit, to the computer, the respective images (e.g., cargo-compartment inside image, first-opening portion vicinity image, and second-opening portion vicinity image).

The variations have been each described, thus far. Note that the above variations may be combined with each other as appropriate.

This application is based on Japanese Patent No. 2021-049749 filed on Mar. 24, 2021, the disclosure of which including the specification, drawings and abstract is incorporated herein by reference in its entirety.

### INDUSTRIAL APPLICABILITY

A loading rate estimation apparatus of the present disclosure is useful for a vehicle equipped with a cargo compartment or a cargo platform.

### REFERENCE SIGNS LIST

1 Cab
2 Cargo compartment
3 Door
4 Cargo-compartment inside camera
5 Rear camera
6 Surveillance camera
100 Loading rate estimation apparatus
110 Recognition section
120 Estimation section
B Berth
V Vehicle

1. A loading rate estimation apparatus, comprising:
a recognition section that acquires at least one of a first image of a captured inside of a cargo platform and/or a second image of a captured range that is an outside of the cargo platform and within a predetermined distance from a doorway of the cargo platform, recognizes and tracks a person and an object other than a cargo in the acquired image, and thereby infers whether the person and the object other than the cargo are present in the cargo platform; and
an estimation section that estimates a loading rate of a vehicle equipped with the cargo platform when neither the person nor the object other than the cargo is present in the cargo platform.

2. The loading rate estimation apparatus according to claim 1, wherein:
the cargo platform is a cargo compartment, and
the first image is an image captured with a camera installed inside the cargo compartment.

3. The loading rate estimation apparatus according to claim 1, wherein the second image is at least one of an image captured with an onboard camera that captures an outside of the vehicle and/or an image captured with a surveillance camera that is installed in a place where an operation on the cargo platform is performed.

4. The loading rate estimation apparatus according to claim 1, wherein:
the person is an operator who performs an operation in or on the cargo platform, and
the object other than the cargo is an operation tool that is used in the operation.
